(19) United States
(12) Patent Application Publication
(10) Pub. No.: US 2024/0360716 A1
(43) Pub. Date: Oct. 31, 2024

(54) BRAKE MODULE

(71) Applicant: Stabilus GmbH, Koblenz (DE)

(72) Inventors: David BURBULLA, Koblenz (DE); Magnus HÜMMERICH, Dierdorf (DE)

(21) Appl. No.: 18/633,666

(22) Filed: Apr. 12, 2024

(30) Foreign Application Priority Data
Apr. 26, 2023 (DE) 202023102252.9

(51) Int. Cl. E05F 5/00; E05F 15/60

(52) U.S. Cl. CPC E05F 5/00; E05F 15/60; E05Y 2201/21; E05Y 2201/26; E05Y 2900/50

(57) ABSTRACT

The invention relates to a brake module (1) for a drive system—in particular, for vehicle hatches—comprising at least one thrust washer (4) and at least one brake disk (3), wherein the at least one thrust washer (4) and the at least one brake disk (3) each have at least one friction surface, which surfaces rub against one another during braking operation, characterized in that the brake disk (3) is formed in one piece from a plastic material and has a number of depressions (18) in the at least one friction surface for receiving a lubricant.

This U.S. patent application claims priority to German Patent Application No. 202023102252.9, filed on Apr. 26, 2023, which is hereby incorporated by reference in its entirety.

The present invention relates to a brake module for a drive system—in particular, for vehicle hatches—comprising at least one thrust washer and at least one brake disk, wherein the at least one thrust washer and the at least one brake disk each have at least one friction surface, which surfaces rub against one another during braking operation.

In drive systems—in particular, in spindle drives used for vehicle doors—it is necessary to apply a load torque in order to optimize the force curve during the extension and retraction of the spindle. On the one hand, this allows a vehicle door to be held, and on the other it allows a uniform movement of the drive system. Damage due to excessive forces due to the weight of the vehicle door or due to excessive manual force by the user can also be avoided. Different brake systems are therefore known from the prior art. Examples include a disk brake with friction partners, a switchable, energized brake consisting of electromagnets with friction partners, or a non-switchable hysteresis brake consisting of two permanent magnets. However, the known braking systems have some disadvantages, such as noise, increased wear, and temperature dependency.

The present invention is therefore based upon the object of providing a brake module for a drive system which can avoid the disadvantages of the known systems and is also designed to be cost-effective.

The subject matter of the present invention provides a brake module for a drive system which achieves this object according to the invention, according to the features of claim 1. The object is also achieved by a drive system according to the features of claim 7. Advantageous embodiments result from the dependent claims.

A brake module according to the invention for a drive system—in particular, for vehicle hatches—has at least one thrust washer and at least one brake disk, wherein the at least one thrust washer and the at least one brake disk each have at least one friction surface, which surfaces rub against one another during braking operation. According to the invention, the brake disk is formed in one piece from a plastic material and has a number of depressions in the at least one friction surface for receiving a lubricant.

In the sense of the invention, the term “vehicle hatch” is understood to mean a component for at least partially closing an opening of a vehicle. In particular, the vehicle hatch can be a vehicle door, an engine hood, a luggage compartment hatch, a cargo compartment door, or a tailgate. The use of the brake module for a device or a structure is also conceivable.

The solution according to the invention provides an optimized combination of the friction partners which offers a simple design and is particularly cost-effective. Due to the depressions for receiving the lubricant, it is also possible to optimize the wear resistance and the noise behavior.

The one-piece design of the brake disk eliminates the need for a complex and cost-intensive coating with one or more friction layers. The brake disk made of a plastic material also has a low weight and is not sensitive to storage.

The depressions serve as a reservoir for a lubricant matched to the friction partners and thus increase the service life of the brake module without requiring large amounts of lubricant.

The brake module can comprise a thrust washer on each of two opposite sides of the brake disk, wherein the brake disk has a friction surface facing each of the thrust washers, each with a friction layer according to the invention. By using two thrust washers on both sides of the brake disk, a longer service life and higher braking force can be achieved without significantly increasing the dimensions of the brake module.

At least one thrust washer can be made of steel-preferably non-nitrided chromium-5 steel. It has been found that a thrust washer made of non-nitrided chromium-5 steel has a shorter service life than a thrust washer made of nitrided chromium-5 steel, but the vibration and noise development due to friction with a brake disk made of fiber-reinforced plastic is significantly reduced compared to nitrided chromium-5 steel. Such a brake module according to the invention with thrust washer(s) made of non-nitrided chromium-5 steel nevertheless has a comparable or even longer service life overall than a brake module from the prior art.

The brake disk can be annular and can in particular have a central opening, wherein the central opening preferably is approximately circular—in particular, having at least two tooth portions separated from one another by a number of recesses, e.g., one, two, three, four, five, six, or seven recesses—wherein the tooth portions preferably comprise teeth that project radially inwards. Such a design allows a more flexible connection of the brake disk, e.g., to a drive shaft—in particular, a threaded spindle of the drive system. It is thus also easier to install the brake module no earlier than late in the production process of a drive system, and to avoid vibration damage during assembly or to remove it if the brake module is defective. An approximately circular cross-section of the opening can mean, for example, that the cross-section is circular except for the radially inward-projecting tooth portions. The recesses are advantageously evenly distributed around the opening in the circumferential direction of the brake disk, i.e., with a constant angular spacing from each other, in order to ensure a uniform load on the brake disk and thus a long service life.

The brake module can comprise a housing in which the brake disk and the at least one thrust washer are guided—preferably coaxially about a central axis—in particular, the longitudinal axis of the drive system—in particular, of a threaded spindle—of the drive system—wherein the brake module preferably comprises a cover disk which is connected to the housing—preferably by a latching connection—in such a way that the brake disk and the at least one thrust washer are held in the housing. The cover disk can, for example, have latching openings in which latching hooks of the housing can engage. Advantageously, the latching connection can be designed such that the cover disk cannot be separated from the housing in a non-destructive manner. This protects components in the housing from tampering.

The structure of the brake module along its longitudinal axis is preferably: spring, thrust washer, brake disk, thrust washer, cover disk. These components are preferably all at least partially enclosed by the housing. A simple assembly of the brake module in the drive system can thus be achieved without the risk of losing a portion of the brake module.

The housing can comprise a number of housing slots whose slot longitudinal axis is advantageously aligned parallel to the longitudinal axis of the drive system. Furthermore, at least one thrust washer can have thrust washer projections, directed outwards radially from the longitudinal axis, which are shaped to be complementary to the housing slots, so that the housing slots and the thrust washer projections cooperate in a positively fitting manner against a rotation of the thrust washer relative to the housing about the longitudinal axis. This prevents the thrust washer from rotating along with the brake disk during a braking, which could reduce or even cancel out the braking effect. By aligning the slot longitudinal axis parallel to the longitudinal axis of the drive system, the thrust washer can simply be inserted into the housing along the longitudinal axis during assembly of the brake module. Advantageously, the housing slots are distributed uniformly around the longitudinal axis in the circumferential direction of the housing, i.e., with a constant angular spacing from one another. The housing is thereby uniformly loaded, which increases its service life.

The object according to the invention is also achieved by a drive system—in particular, for a vehicle hatch—comprising a brake module according to one of the preceding embodiments.

The present invention is described below with reference to an exemplary embodiment. The drawings, the description, and the claims contain numerous features in combination. A person skilled in the art will expediently also consider the features individually and combine them to form expedient further combinations.

In the drawings:

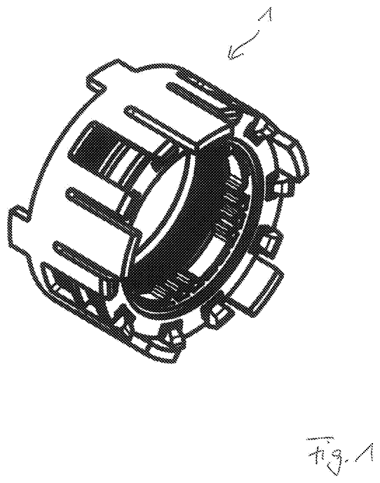

FIG. 1 is a spatial representation of a brake module according to the invention;

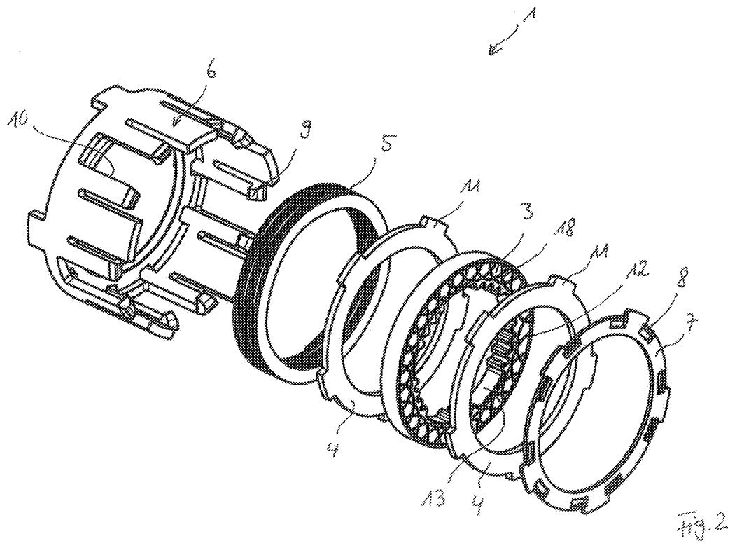

FIG. 2 is an exploded view of the brake module from FIG. 1;

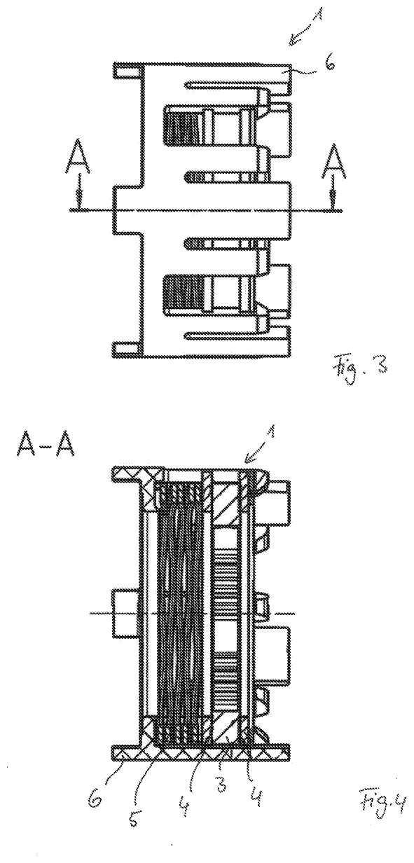

FIG. 3 is a side view of the brake module from FIG. 1;

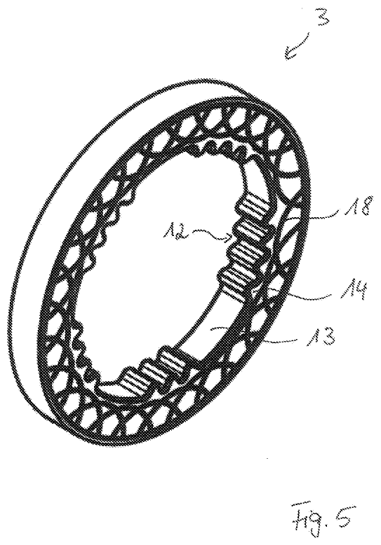

FIG. 4 is a cross-section A-A of the brake module from FIG. 3;

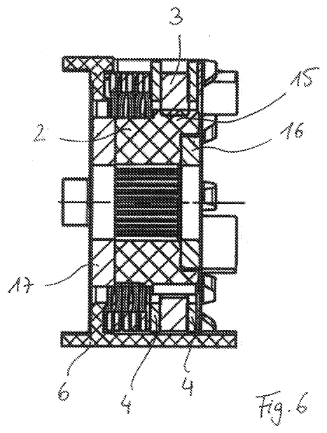

FIG. 5 is an enlarged spatial representation of a brake disk of the brake module from FIG. 1, and

FIG. 6 is a further cross-section of the brake module from FIG. 3 with a driver element of the drive system.

FIG. 1 shows a brake module 1 according to the invention in a spatial representation. The brake module 1 is connected, e.g., via a driver 2 shown in FIG. 6, to a spindle (not shown) of a drive system. The drive system can be an electrical spindle drive, known for example from EP 1 767 439 A2. The spindle is rotationally driven by a drive unit designed as an electric motor, whereby fastening elements of the spindle drive can be moved relative to one another in order for example to open or close a vehicle hatch.

FIG. 2 shows the brake module 1 of FIG. 1 in an exploded view. The brake disk 3 comprises at least two friction surfaces which rub against adjacent friction surfaces of two thrust washers 4 in braking operation as a result of rotation of the brake disk 3 relative to the thrust washers 4 about a longitudinal axis of the spindle or of the drive system. A braking torque is thereby exerted on the spindle of the drive system. A spring 5 exerts a spring force along the longitudinal axis on one of the thrust washers 4, whereby the brake disk 3 and the thrust washers 4 are pressed against one another in order to hold them in frictional contact. The strength of the spring force is a parameter via which the magnitude of the braking force can be determined. In this embodiment, the spring 5 is a wave spring.

The brake disk 3, the thrust washers 4, the spring 5, and a cover disk 7 are arranged in a housing 6, guided coaxially about the longitudinal axis. The housing 8 is connected to the cover disk 7 by a latching connection, whereby the brake disk 3, the two thrust washers 4, and the spring 5 are held in the housing 6. The cover disk 7 can, for example, have latching openings 8 in which latching hooks 9 of the housing 8 can engage. The structure of the brake module along its longitudinal axis is thus: spring 5, thrust washer 4, brake disk 3, thrust washer 4, cover disk 7. These components are all at least partially surrounded by the housing 6 when assembled. A simple assembly of the brake module 1 in the drive system can thus be achieved without the risk of losing a part of the brake module 1.

The housing 6 further comprises a number, e.g., five, of housing slots 10 evenly distributed around the longitudinal axis in the circumferential direction of the housing 6, and having a slot longitudinal axis parallel to the longitudinal axis. Thrust washer projections 11 of the thrust washers 4, which are directed radially outwards from the longitudinal axis, engage in the housing slots 10. This prevents a rotation of the housing 6 and the thrust washers 4 relative to each other around the longitudinal axis when the brake disk 3 rotates with the spindle and rubs against the thrust washers 4 during braking operation.

The brake disk 3 is annular and has a central opening. The central opening has an approximately circular cross-section with at least two, e.g., four, tooth portions 12, uniformly distributed about the longitudinal axis in the circumferential direction of the brake disk 3 and separated from one another by recesses 13. The design of the brake disk 3 is visible in particular in FIG. 5, which shows an enlarged representation of the brake disk 3. The tooth portions 12 comprise teeth 14 that project radially inwards. Such a design allows a flexible connection of the brake disk 3 to the spindle of the drive system via the driver 2 shown in FIG. 6. The driver 2 comprises wings 15 that engage in the recesses 13 of the brake disk 3. The torque is transmitted between the driver 2 and the brake disk 3 via the contact between the wings 15 and the teeth 14.

As can be seen in particular in FIG. 5, the friction surfaces of the brake disk have a number of depressions 18 for receiving a lubricant, by means of which it is possible to optimize the wear resistance and the noise behavior. The depressions 18 are formed as overlapping circular segments that open radially outwards. This geometry makes it possible for as much lubricant as possible to remain in frictional contact for as long as possible.

The one-piece design of the brake disk eliminates the need for a complex and cost-intensive coating with one or more friction layers. The brake disk made of a plastic material also has a low weight and is not sensitive to storage.

The depressions serve as a reservoir for a lubricant matched to the friction partners and thus increase the service life of the brake module without requiring large amounts of lubricant.

Further disk elements 16, 17 shown in FIG. 6 secure the positioning of the driver 2 on the spindle (not shown) of the spindle drive.

1. Brake module for a drive system—in particular, for vehicle hatches—comprising at least one thrust washer and at least one brake disk, wherein the at least one thrust washer and the at least one brake disk each have at least one friction surface, which surfaces rub against one another during braking operation, characterized in that the brake disk is formed in one piece from a plastic material and has a number of depressions in the at least one friction surface for receiving a lubricant.

2. Brake module according to claim 1, characterized in that the brake module comprises a thrust washer on each of two opposite sides of the brake disk, wherein the brake disk has a friction surface facing each of the thrust washers.

3. Brake module according to claim 1, characterized in that at least one thrust washer is made of chromium-5 steel.

4. Brake module according to claim 1, characterized in that the brake disk is annular and has a central opening, wherein the central opening has an approximately circular cross-section with at least two tooth portions separated by recesses.

5. Brake module according to claim 1, characterized in that the brake module comprises a housing in which the brake disk and the at least one thrust washer are guided coaxially about a central axis, wherein the brake module comprises a cover disk which is connected to the housing by a latching connection in such a way that the brake disk and the at least one thrust washer are held in the housing.

6. Brake module according to claim 5, characterized in that the housing comprises a number of housing slots whose slot longitudinal axis is aligned parallel to the longitudinal axis of the drive system, wherein at least one thrust washer has thrust washer projections directed radially outwards from the longitudinal axis which are shaped to be complementary to the housing slots, so that the housing slots and the thrust washer projections cooperate in a positively locking manner against a rotation of the thrust washer relative to the housing about the longitudinal axis.

7. Drive system—in particular, for a vehicle hatch—comprising a brake module according to claim 1.

8. Drive system according to claim 7, characterized in that the drive system is an electrical spindle drive.
